(19) United States
(12) Patent Application Publication
(10) Pub. No.: US 2014/0024756 A1
(43) Pub. Date: Jan. 23, 2014

(54) Pressure-Sensitive Adhesive for an Adhesive Tape and Use thereof in an Adhesive Tape

(71) Applicant: tesa SE, Hamburg (DE)

(72) Inventors: Thorsten Krawinkel, Hamburg (DE); Gaelle de Roton, Hamburg (DE)

(73) Assignee: tesa SE, Hamburg (DE)

(21) Appl. No.: 13/946,326

(22) Filed: Jul. 19, 2013

(30) Foreign Application Priority Data
Jul. 23, 2012 (DE) 10 2012 212 879.4

(51) Int. Cl. C09J 123/24; C09J 153/02

(52) U.S. Cl. CPC C09J 123/24; C09J 153/02
USPC 524/271; 524/505

(57) ABSTRACT

The invention relates to a pressure-sensitive adhesive comprising at least 70 wt. % of a mixture of (i) block copolymers comprising a mixture of block copolymers having the structure I and II A′-B′, A-B-A, (A-B)ₙ, (A-B)ₙX and/or (A-B-A)ₙX, where
X is the residue of a coupling reagent,
n is an integer between 2 and 10,
A and A′ are each a polymer block of a vinylaromatic,
B and B′ are each a polymer block formed from butadiene, a mixture of butadiene and isoprene and/or a mixture of butadiene and styrene and
A and A′, and B and B′, may each be identical or different,
   (ii) at least one tackifier resin.

The invention relates to a pressure-sensitive adhesive which is based on styrene block copolymers and distinguished by particularly high and balanced bond strengths on polar and non-polar substrates, and also to its use.

Pressure-sensitive adhesives (PSAs) are adhesives which even under a relatively weak applied pressure permit a durable connection with the substrate and which after service can be detached from the substrate again substantially without residue. PSAs are permanently pressure-sensitively adhesive at room temperature, thus having a sufficiently low viscosity and a high tack, meaning that they wet the surface of the respective substrate under even low applied pressure. The adhesive bonding capacity of the adhesives and their redetachability derive from their adhesive properties and from their cohesive properties. A variety of compounds are contemplated as a basis for PSAs.

Adhesive tapes furnished with PSAs, referred to as pressure-sensitive adhesive tapes, are presently in diverse use within the industrial and household spheres. Pressure-sensitive adhesive tapes consist typically of a carrier film, furnished on one or both sides with a PSA. There are also pressure-sensitive adhesive tapes which consist exclusively of a PSA layer and no carrier film, these being known as transfer tapes. The composition of the pressure-sensitive adhesive tapes may vary greatly and is dependent on the particular requirements of the various applications. The carriers typically consist of polymeric films, such as polypropylene, polyethylene or polyesters (for example polyethylene terephthalate), for example, or else of paper, woven fabric or nonwoven material.

The self-adhesives or PSAs are based generally on acrylate copolymers, silicones, natural rubber, synthetic rubber, styrene block copolymers or polyurethanes.

There is a need for adhesive tapes which exhibit a very high bonding strength on polar and non-polar substrates, but also do not lose their cohesion at elevated temperatures. In the case of adhesive bonds in the exterior sector or in motor vehicles, in particular, temperatures of more than 60° C. to 70° C. may occur. For adhesive tapes with particularly high holding performance, especially in the consumer segment, adhesives based on styrene block copolymers are frequently employed. An advantage of these adhesives is that they are able to exhibit very high bonding strength in tandem with very high cohesion. As a result of a high tack, even bonds to rough substrates are securely possible.

Typically used are linear or radial block copolymers based on polystyrene blocks and polybutadiene blocks and/or polyisoprene blocks—i.e., for example, radial styrene-butadiene (SB), and/or linear styrene-butadiene-styrene (SBS) and/or linear styrene-isoprene-styrene (SIS) block copolymers.

The products that are on the market with PSAs based on styrene block copolymers exhibit weaknesses in their bonding strength at temperatures above 50° C. Especially when being used for bonding articles of moderate weight, the softening of the hard phases consisting principally of polystyrene (block polystyrene domains) results in cohesive failure of the pressure-sensitive adhesive strips.

Bond failure occurs to a significantly greater extent in particular in the case of a tipping shear load (when a torque is active, such as when bonding a hook, for example) than in the case of a purely shearing load.

It is an object of the invention, therefore, to provide an improved PSA based on styrene block copolymers particularly for adhesive tapes which exhibit good bonding strength on both polar and non-polar substrates.

This object is achieved by means of a PSA as specified in the main claim. The dependent claims provide advantageous developments of the subject matter of the invention. The invention further embraces the use of this PSA.

The invention relates accordingly to a pressure-sensitive adhesive comprising at least 70 wt. %, preferably 80 wt. %, of a mixture of
(i) block copolymers comprising a mixture of block copolymers having the structure I and II
   I) A′-B′
   II) A-B-A, (A-B)ₙ, (A-B)ₙX and/or (A-B-A)ₙX, where
      X is the residue of a coupling reagent,
      n is an integer between 2 and 10,
      A and A′ are each a polymer block of a vinylaromatic,
      B and B′ are each a polymer block formed from butadiene, a mixture of butadiene and isoprene and/or a mixture of butadiene and styrene and
      A and A′, and B and B′, may each be identical or different,
(ii) at least one tackifier resin,
   the fraction of the block copolymers I) being between 30 and 70 wt. %, based on the total amount of block copolymers,
   the fraction of A in the block copolymers II) being between 25 and 40 wt. %, and the A-B unit within at least one of the vinylaromatic block copolymers of structure II having a molecular weight M_{w} of greater than 65 000 g/mol, and the molecular weight M_{w} of the overall block copolymer II being greater than 130 000 g/mol.

With preference, all A-B units within at least one of the vinylaromatic block copolymers of the structure II have a molecular weight M_{w} of greater than 65 000 g/mol.

With further preference, all A-B units in all the vinylaromatic block copolymers of the structure II have a molecular weight M_{w} of greater than 65 000 g/mol.

According to one advantageous embodiment of the invention, the PSA comprises as elastomers only a mixture of vinylaromatic block copolymers of the structures I and II.

The mixture may consist of precisely one vinylaromatic block copolymer of structure I and precisely one vinylaromatic block copolymer of structure II.

In an alternative embodiment of the invention the mixture comprises a plurality of different vinylaromatic block copolymers of structure I and/or or structure II, preferably at the same time two or more different vinylaromatic block copolymers of structure I and of structure II.

According to another preferred embodiment of the invention the fraction of the vinylaromatic block copolymer or of the vinylaromatic block copolymers of structure I in the sum total of the vinylaromatic block copolymers of structures I and II is between 50 and 65 wt. %.

According to another preferred embodiment of the invention the fraction(s) of the vinylaromatic end block A′ in the block copolymer of the structure I is(are) between 20 and 40 wt. %, preferably between 25 and 33 wt. %.

In a variant of the invention the fraction(s) of the vinylaromatic end block A′ in the block copolymer of structure I is(are) between 13 and 20 wt. %.

As vinylaromatics A and/or A′ within the vinylaromatic block copolymers it is possible for example to employ styrene, vinyltoluene, α-methylstyrene, chlorostyrene, o- or p-methylstyrene, 2,5-dimethylstyrene, p-methoxystyrene and/or p-tert-butylstyrene.

The polymer B and/or B′ may be formed from butadiene alone or in a mixture with isoprene or styrene. Both block structures and randomly distributed monomer are possible in this context.

Customary coupling reagents for producing diblock, triblock, multiblock and star block copolymers are known to the skilled person. To name but a few, examples include 2-vinylpyridine, 1,4-di(bromomethyl)benzene, dichlorodimethylsilane or 1,2-bis(trichloro-silyl)ethane, without confining the coupling reagents to these only. Of these coupling reagents, X remains as a residue after coupling.

Besides the vinylaromatic block copolymers, the PSA comprises at least one tackifier resin, in order to raise the adhesion desirably. The tackifier resin ought to be compatible with the elastomer block in the block copolymers.

In one advantageous embodiment of the invention the adhesive consists only of the vinylaromatic block copolymers and of one or more tackifier resins.

Suitable tackifier resins include preferably unhydrogenated, partially hydrogenated or fully hydrogenated resins based on rosin or rosin derivatives, hydrogenated polymers of dicyclopentadiene, unhydrogenated, or partially, selectively or fully hydrogenated hydrocarbon resins based on C₅, C₅/C₉ or C₉ monomer streams or, with particular preference, polyterpene resins based on a-pinene and/or β-pinene and/or δ-limonene. Aforementioned tackifier resins may be used either alone or in a mixture. Moreover, the adhesive formulation may also include tackifier resins which are liquid at room temperature.

The glass transition temperature of the resin mixture used, measured by DSC (heating rate 20° C./min), is more than 50° C., preferably more than 60° C.

The pressure-sensitive adhesive consists preferably only of the vinylaromatic block copolymers and of the tackifier resin or resins.

The adhesive may be admixed with customary adjuvants such as ageing inhibitors, antioxidants, light stabilizers, etc.

Typically employed as adjuvants to the adhesive are the following:
plasticizing agents such as, for example, plasticizer oils or low molecular mass liquid polymers such as low molecular mass polybutenes, for example
primary antioxidants such as, for example, sterically hindered phenols
secondary antioxidants such as, for example, phosphites or thioethers
in-process stabilizers such as, for example, C radical scavengers
light stabilizers such as, for example, UV absorbers or sterically hindered amines
processing assistants
wetting additives
adhesion promoters and/or
optionally further polymers of preferably elastomeric kind; elastomers utilizable accordingly include, among others, those based on pure hydrocarbons, as for example unsaturated polydienes such as natural or synthetically generated polyisoprene or polybutadiene, elastomers with substantial chemical saturation, such as, for example, saturated ethylene-propylene copolymers, a-olefin copolymers, polyisobutylene, butyl rubber, ethylene-propylene rubber, and also chemically functionalized hydrocarbons such as, for example, halogen-containing, acrylate-containing, allyl or vinyl ether-containing polyolefins, to name but a few.

According to one preferred embodiment of the invention the group of the adjuvants embraces only ageing inhibitors, antioxidants, plasticizers, processing assistants, wetting additives, adhesion promoters and light stabilizers.

The adjuvants are not mandatory; the adhesive works even without their addition individually or in any desired combination.

According to a further advantageous embodiment of the invention the PSA consists only of the vinylaromatic block copolymers, the tackifier resin or resins, and one or more adjuvants selected from the following group:
plasticizing agents such as, for example, plasticizer oils or low molecular mass liquid polymers such as low molecular mass polybutenes, for example
primary antioxidants such as, for example, sterically hindered phenols
secondary antioxidants such as, for example, phosphites or thioethers
in-process stabilizers such as, for example, C radical scavengers
light stabilizers such as, for example, UV absorbers or sterically hindered amines
processing assistants
wetting additives
adhesion promoters.

With further preference the entire fraction of the adjuvants in the PSA, based in each case on the overall composition of the PSA, is not more than 20 wt. %, more preferably not more than 10 wt. %.

The fraction of the vinylaromatic block copolymers of structures I and II in the PSA is preferably between 40 wt. % and 60 wt. %, more particularly in the range between 45 wt. % and 55 wt. %, based in each case on the overall composition of the PSA.

According to one preferred embodiment of the invention the PSA, based in each case on the overall composition of the PSA, has the following constitution:
vinylaromatic block copolymer: 40 wt. % to 60 wt. %, more particularly 45 wt. % to 55 wt. %
tackifier resin or resins: 40 wt. % to 60 wt. %, more particularly 45 wt. % to 55 wt. %.

According to another preferred embodiment of the invention the PSA, based in each case on the overall composition of the PSA, has the following constitution:
vinylaromatic block copolymer: 30 wt. % to 59.8 wt. %, more particularly 45 wt. % to 55 wt. %
tackifier resin or resins: 40 wt. % to 50 wt. %, more particularly 45 wt. % to 55 wt. %
adjuvants, more particularly confined to the group stated above: 0.2 wt. % to 20 wt. %, more particularly 0.5 wt. % to 10 wt. %.

The PSAs may be produced and processed from solution, from dispersion and from the melt. Preferred production and processing procedures are accomplished from solution and also from the melt.

The adhesive of the invention can be employed with particular advantage in a single-sided or double-sided adhesive tape. This presentation allows particularly simple and uniform application of the adhesive.

The general expression “adhesive tape” here encompasses a carrier material which has been provided on one or both sides with a pressure-sensitive adhesive (PSA). The carrier material embraces all sheetlike structures, examples being two-dimensionally extended sheets or sheet sections, tapes with extended length and limited width, tape sections, diecuts, multilayer arrangements and the like. For different applications, any of a very wide variety of different carriers may be combined, such as films, fabrics, nonwovens and papers, for example, with the adhesives. Furthermore, the expression “adhesive tape”, also encompasses what are called “adhesive transfer tapes”, in other words an adhesive tape without carrier. In the case of an adhesive transfer tape, the adhesive is instead applied prior to application between flexible liners which have been provided with a release coat and/or which have antiadhesive properties. For application, generally one liner is first removed, the adhesive is applied, and then the second liner is removed. In this way the adhesive can be used directly to join two surfaces.

The adhesive may be provided in fixed lengths, such as in the form of metre product, for example, or else as continuous product on rolls (archimedean spiral).

The carrier material employed in the present context for an adhesive tape is preferably polymer sheets or film composites. Such sheets/film composites may consist of all common plastics used for producing films, examples—but without restriction—including the following:

polyethylene, polypropylene—especially the oriented polypropylene (OPP) generated by monoaxial or biaxial stretching; polyvinyl chloride (PVC), polyesters—especially polyethylene terephthalate (PET) and polyethylene naphthalate (PEN), polyacrylonitrile (PAN), polycarbonate (PC), polyamide (PA), polyethersulphone (PES) or polyimide (PI). Furthermore, the sheets/film composites may in a preferred embodiment be made transparent, so that the overall construction of an adhesive article of this kind is also transparent. “Transparency” here as well denotes an average transmission in the visible range of light of at least 75%, preferably higher than 90%.

It is also possible, furthermore, to use carriers based on paper, fabric and/or nonwoven.

In the case of double-sidedly (self-)adhesive tapes, adhesives of the invention that are the same or different, with the same or different layer thickness, may be employed as the top and bottom layers. The carrier in this case may have been pretreated in accordance with the prior art on one or both sides, to obtain, for example, an improvement in adhesive anchoring. It is also possible for one or both sides to have been provided with a functional layer which is able, for example, to function as a barrier layer. The PSA layers may optionally be lined with release papers or release films. Alternatively only one layer of adhesive may have been lined with a double-sidedly releasing liner.

Further details, aims, features and advantages of the present invention will be elucidated in more detail below in reference to a plurality of figures which represent preferred exemplary embodiments and in which

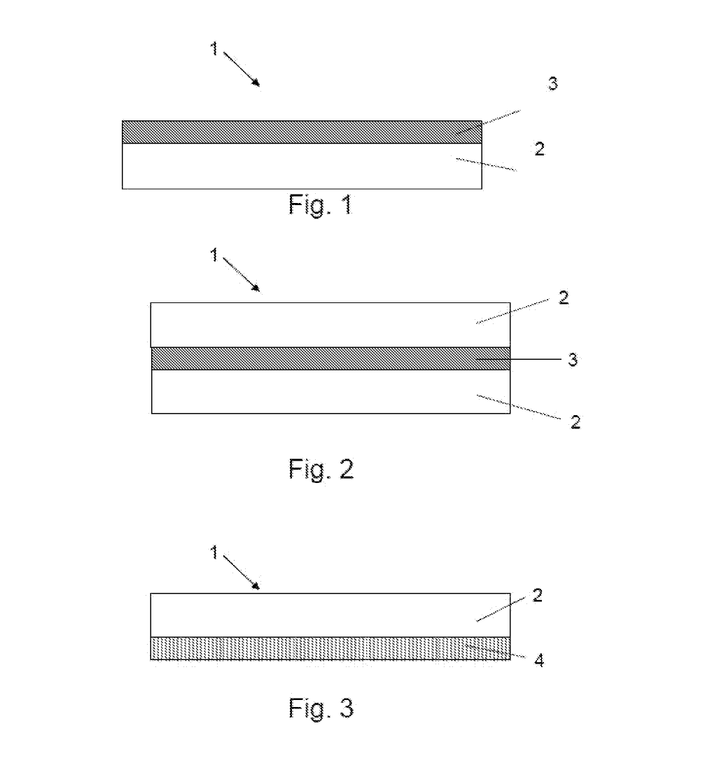

FIG. 1 shows a single-sided pressure-sensitive adhesive tape,

FIG. 2 shows a double-sided pressure-sensitive adhesive tape, and

FIG. 3 shows a carrier-free pressure-sensitive adhesive tape (adhesive transfer tape).

FIG. 1 shows a single-sidedly adhesive pressure-sensitive adhesive tape 1. The pressure-sensitive adhesive tape 1 has an adhesive layer 2 which has been produced by coating one of the above-described PSAs onto a carrier 3. The PSA coatweight is preferably between 10 and 50 g/m².

Additionally (not shown) there may also be a release film provided that lines and protects the adhesive layer 2 prior to the use of the pressure-sensitive adhesive tape 1. In that case the release film is removed from the adhesive layer 2 prior to use.

The product construction shown in FIG. 2 depicts a pressure-sensitive adhesive tape 1 with a carrier 3 which is coated on both sides with a PSA and thus has two adhesive layers 2. The PSA coatweight per side is again preferably between 10 and 200 g/m².

With this embodiment as well, preferably at least one adhesive layer 2 is lined with a release film. In the case of a rolled-up adhesive tape, this release film may optionally also line the second adhesive layer 2. It is possible, however, for two or more release films to be provided.

A further possibility is for the carrier film to be provided with one or more coatings. Moreover, only one side of the pressure-sensitive adhesive tape may be equipped with the inventive PSA, and a different PSA may be used on the other side.

The product construction shown in FIG. 3 depicts a pressure-sensitive adhesive tape 1 in the form of an adhesive transfer tape—that is, a carrier-free pressure-sensitive adhesive tape 1. For this purpose, the PSA is coated on one side onto a release film 4 and thus forms a pressure-sensitive adhesive layer 2. The PSA coatweight here is typically between 10 and 50 g/m². This pressure-sensitive adhesive layer 2 is optionally lined on its second side with a further release film. The release films in that case are removed for the use of the pressure-sensitive adhesive tape.

As alternatives to release films it is also possible, for example, to use release papers or the like. In that case, however, the surface roughness of the release paper ought to be reduced, in order to produce an extremely smooth PSA side.

### Production of the Pressure-Sensitive Adhesive Strips

The constituents of the PSAs were dissolved here in toluene/acetone 3:1 (solids content 40%) and coated by means of a coating bar onto a PET film with a thickness of 36 μm, to give a measurable coatweight after drying at 100° C. of 50 g/m².

### Test Methods

Unless indicated otherwise, the measurements are conducted under test conditions of 23±1° C. and 50±5% relative atmospheric humidity.

### Bond Strength

The bond strength is determined as follows: a steel surface or a polyester film is used as the defined substrate. The bondable sheetlike element under investigation is cut to a width of 20 mm and a length of approximately 25 cm, equipped with a handling section, and immediately thereafter pressed onto the substrate five times using a 4 kg steel roller with a rate of advance of 10 m/min. Immediately after that, the bondable sheetlike element is peeled from the substrate using a tensile tester (from Zwick), at an angle of 180° and a peel velocity of 300 mm/min, and the force required to accomplish this is recorded. The measurement (in N/cm) is obtained as an average value from three individual recordings.

### Static Shear Test

The shear strength is a measure of the internal strength of the adhesive and is tested in a test known as the static shear test, as follows: a 20×13 mm strip of the adhesive tape, with a single-sided coating of the adhesive with a coatweight of 50 g/m², is adhered to the test substrate (steel: material in accordance with DIN EN 10088-2, type 1, 4301, surface quality 2R, cold-rolled and bright-annealed, Rₐ 25 to 75 nm). The prepared test specimen is rolled down four times with a 2 kg weight at a velocity of 0.03 m/min and then loaded with a weight for shearing. The outcome reported is the time in minutes taken for the adhesive tape to shear off from the test substrate. The results set out in Table 2 are obtained for loading of the specimens at 5 N and at 70° C.

### Static Glass Transition Temperature T_{g}

The static glass transition temperature is determined by dynamic scanning calorimetry in accordance with DIN 53765. The figures given for the glass transition temperature T_{g} relate to the glass transformation temperature value T_{g} in accordance with DIN 53765: 1994-03, unless specifically indicated otherwise.

### Molecular Weight

The average molecular weight M_{w} is determined by means of gel permeation chromatography (GPC). The eluent used is THF with 0.1 vol % of trifluoroacetic acid. Measurement takes place at 25° C. The preliminary column used is PSS-SDV, 5 μm, 10³ Å, ID 8.0 mm×50 mm. Separation takes place using the columns PSS-SDV, 5 μm, 10³ Å, 10⁵ Å and 10⁶ Å each with ID 8.0 mm×300 mm. The sample concentration is 4 g/l and the flow rate is 1.0 ml per minute. Measurement takes place against PMMA standards.

### EXAMPLES

The invention is elucidated in more detail below by means of a number of examples, without wishing thereby to restrict the invention.

Composition of the examples in weight fractions—see table

| | | | | | C5 | C6 |
|---|---|---|---|---|---|---|
| | | | | | (Comparative | (Comparative |
| | 1 | 2 | 3 | 4 | example) | example) |
| Kraton D 1101 | 33.0 | | 33 | 17 | 50 | |
| Kraton D 1118 | 17.0 | 33.0 | | 33 | | |
| Vector 4113 | | 17.0 | | | | |
| Solprene 1205 | | | 17 | | | 50 |
| Pentalyn H-E | 48.0 | 48.0 | 48 | | 48 | 48 |
| Dercolyte A | | | | 48 | | |
| 115 | | | | | | |
| Wingtack 10 | | | | 2 | | |
| Shellflex 371 | 2.0 | 2.0 | 2 | | 2 | 2 |

Kraton D 1118 SBS, 76 wt. % diblock, block polystyrene content: 31 wt. %, Kraton Polymers (molecular weight M_{w} of the 3-block fraction of 150 000 g/mol)
Kraton D 1101 SBS, 16 wt. % diblock, block polystyrene content: 31 wt. %, Kraton Polymers (molecular weight M_{w} of the 3-block fraction of 150 000 g/mol)
Solprene 1205 SB, 100 wt. % diblock, block polystyrene content: 18 wt. %, Dynasol
Pentalyn-HE hydrogenated pentaerythritol ester of rosin, softening point (Ring & Ball) 110° C., Eastman
Dercolyte A 115 α-pinene resin, softening temperature: 115° C., DRT
Wingtack 10 liquid hydrocarbon resin, Cray Valley
Shellflex 371 naphthenic oil, Shell

The Ring and Ball method is the usual method for ascertaining softening points. Details can be found in ASTM E 28 and DIN EN 1238, hereby expressly incorporated by reference.

For the exemplary pressure-sensitive adhesive strips, the following technical adhesive data were ascertained:

| | | | | | C5 | C6 |
|---|---|---|---|---|---|---|
| | | | | | (Comparative | (Comparative |
| | 1 | 2 | 3 | 4 | example) | example) |
| Bond strength | 8.5 | 10.9 | 9.4 | 9.2 | 7.5 | 10.4 |
| to steel | | | | | | |
| Bond strength | 3.5 | 6.4 | 4.1 | 4.8 | 1.2 | 5.5 |
| to PE | | | | | | |
| Holding power | >10 000 | 3400 | 7900 | >10 000 | 1200 | 200 |
| at 70° C. (0.5 kg) | | | | | (adhesive | |
| (cohesive | | | | | failure) | |
| failure) | | | | | | |

As the examples show, the advantage of the PSA of the invention lies in the very high bond strength in conjunction with high holding power. The adhesive bonds very well both to polar and to non-polar substrates. Surprisingly, the temperature stability is much better than for the normal adhesives based on styrene block copolymers, as evident from the high holding power at 70° C.

1. A pressure-sensitive adhesive comprising at least 70 wt. % of a mixture of
(i) block copolymers comprising a mixture of block copolymers having the structure I and II
I) A′-B′
II) A-B-A, (A-B)ₙ, (A-B)ₙX and/or (A-B-A)ₙX, where
X is the residue of a coupling reagent,
n is an integer between 2 and 10,
A and A′ are each a polymer block of a vinylaromatic,
B and B′ are each a polymer block formed from butadiene, a mixture of butadiene and isoprene and/or a mixture of butadiene and styrene and
A and A′, and B and B′, may each be identical or different,
(ii) at least one tackifier resin,
the fraction of the block copolymers I) being between 30 and 70 wt. %, based on the total amount of block copolymers,
the fraction of A in the block copolymers II) being between 25 and 40 wt. %, and the A-B unit within at least one of the vinylaromatic block copolymers of structure II having a molecular weight M_{w}, of greater than 65 000 g/mol, and the molecular weight M_{w} of the overall block copolymer II being greater than 130 000 g/mol.

2. The pressure-sensitive adhesive according to claim 1, wherein the pressure-sensitive adhesive comprises as elastomers only a mixture of vinylaromatic block copolymers of structures I and II, it being possible for the mixture to consist of in each case one vinylaromatic block copolymer of structure I and one vinylaromatic block copolymer of structure II or for the mixture to consist of a plurality of different vinylaromatic block copolymers of structures I and II.

3. The pressure-sensitive adhesive according to claim 1 wherein the fraction of the vinylaromatic block copolymer or of the vinylaromatic block copolymers of structure I as part of the sum total of the vinylaromatic block copolymers of structures I and II is between 30 and 70 wt. %.

4. The pressure-sensitive adhesive according to claim 3 wherein the fraction or fractions of the vinylaromatic end block A′ in the block copolymer of the structure I is or are between 20 and 40 wt. %.

5. The pressure-sensitive adhesive according to claim 4 wherein the fraction or fractions of the vinylaromatic end block A′ in the block copolymer of the structure I is or are between 13 and 20 wt. %.

6. The pressure-sensitive adhesive according to claim 1 wherein the tackifier resins used are unhydrogenated, partially hydrogenated or fully hydrogenated resins based on rosin or rosin derivatives, hydrogenated polymers of dicyclopentadiene, unhydrogenated, partially hydrogenated, selectively hydrogenated or fully hydrogenated hydrocarbon resins based on C₅, C₅/C₉ or C₉ monomer streams, or, polyterpene resins based on a-pinene and/or β-pinene and/or δ-limonene.

7. The pressure-sensitive adhesive according to claim 1 wherein the fraction of the vinylaromatic block copolymers of structures I and II in the pressure-sensitive adhesive is between 40 wt. % and 60 wt. %, based in each case on the overall composition of the pressure-sensitive adhesive.

8. The pressure-sensitive adhesive according to claim 1 wherein the pressure-sensitive adhesive has the following composition:
vinylaromatic block copolymer: 40 wt. % to 60 wt. %, and
tackifier resin or resins: 40 wt. % to 60 wt. %.

9. The pressure-sensitive adhesive according to claim 1 wherein the vinylaromatics used are styrene, vinyltoluene, a-methylstyrene, chlorostyrene, o- or p-methylstyrene, 2,5-dimethylstyrene, p-methoxystyrene and/or p-tert-butylstyrene.

10. The pressure-sensitive adhesive according to claim 8 wherein the pressure-sensitive adhesive consists only of the vinylaromatic block copolymers and of the tackifier resin or resins.

11. (canceled)
